(19) United States
(12) Patent Application Publication
(10) Pub. No.: US 2022/0150098 A1
(43) Pub. Date: May 12, 2022

(54) TRANSMITTING AND RECEIVING METHODS AND DEVICES FOR POSITIONING REFERENCE SIGNAL, AND TRANSMITTING AND RECEIVING NODES

(71) Applicant: ZTE CORPORATION, Shenzhen, Guangdong (CN)

(72) Inventors: Cheng BI, Shenzhen, Guangdong (CN); Yifei YUAN, Shenzhen, Guangdong (CN); Shijun CHEN, Shenzhen, Guangdong (CN); Wanfu XU, Shenzhen, Guangdong (CN)

(21) Appl. No.: 17/437,520

(22) PCT Filed: Mar. 26, 2020
(86) PCT No.: PCT/CN2020/081348

§ 371 Date: Sep. 9, 2021

(30) Foreign Application Priority Data
Mar. 27, 2019 (CN) 201910239843.X

(51) Int. Cl. H04L 27/26; H04L 5/00; H04W 72/04

(52) U.S. Cl. CPC H04L 27/2613; H04L 27/26025; H04W 72/0453; H04W 72/0446; H04L 5/0051

(57) ABSTRACT

The present disclosure provides transmitting and receiving methods and devices for positioning reference signal, transmitting and receiving nodes and computer-readable storage media. The transmitting method includes: allocating time-frequency resources to PRS resource blocks according to subcarrier spacing; and transmitting the PRS resource blocks according to the allocated time-frequency resources, with each PRS resource block including resource block identification information.

### TECHNICAL FIELD

The present disclosure relates to, but is not limited to, transmitting and receiving methods and devices for positioning reference signal, transmitting and receiving nodes and computer-readable storage media.

### BACKGROUND

With an increase in the frequency of radio waves used in mobile communication, a path loss also increases. Based on the fact that a size of an antenna is fixed relative to a wavelength of radio waves, it is possible to compensate for a high frequency path loss by increasing the number of antennas, without increasing a size of an antenna array. Moreover, the difficulty of signal coverage is greatly increased due to an increase in reflection, diffraction and building penetration loss. Massive Multiple-Input Multiple-Output (Massive MIMO) can generate adjustable high-gain shaped beams, significantly improve signal coverage and reduce interference to surrounding areas, so that the Massive MIMO is widely applied to 5th generation mobile networks (5G).

The support for positioning has been introduced since LTE Release 9 (Long Term Evolution Release 9), and Positioning Reference Signal (PRS) has also been introduced to realize downlink positioning. In general, a receiving node needs to measure downlink signals transmitted from one or several cells to obtain a measurement result, which is further used to calculate a position.

Downlink PRSs to be measured are all transmitted in a broadcasting way before the 5G, but a design of 5G PRS should support transmitting PRSs in a form of beams according to the recent New Radio positioning Study Item (NR positioning SI). However, in a case where a plurality of PRS resource blocks transmit the same information through beam scanning within one PRS burst, a receiving node cannot identify received PRS blocks when receiving the PRS blocks, thus the receiving node cannot determine service beams.

### SUMMARY

A summary of the subject matter which is described in detail herein is provided below, but the summary is not intended to limit the scope of the claims.

The embodiments of the present disclosure provide transmitting and receiving methods and devices for PRS, transmitting and receiving nodes and computer-readable storage media, so as to transmit and receive PRSs in the form of beams.

An embodiment of the present disclosure provides a transmitting method for PRS, including: allocating time-frequency resources to PRS resource blocks according to subcarrier spacing; and transmitting the PRS resource blocks according to the allocated time-frequency resources, with each PRS resource block including resource block identification information.

An embodiment of the present disclosure further provides a receiving method for PRS, including: determining time-frequency resources via which PRS resource blocks are transmitted according to subcarrier spacing; and detecting and receiving the PRS resource blocks according to the determined time-frequency resources, with each PRS resource block including resource block identification information.

An embodiment of the present disclosure further provides a transmitting device for PRS, including: an allocation module configured to allocate time-frequency resources to PRS resource blocks according to subcarrier spacing; and a transmitting module configured to transmit the PRS resource blocks according to the allocated time-frequency resources, with each PRS resource block including resource block identification information.

An embodiment of the present disclosure further provides a transmitting node, including: a memory, a processor, and a computer program which is stored on the memory and is executable by the processor. When executing the program, the processor performs the transmitting method for PRS.

An embodiment of the present disclosure further provides a computer-readable storage medium having computer-executable instructions stored therein. The computer-executable instructions are configured to perform the transmitting method for PRS.

An embodiment of the present disclosure further provides a receiving device for PRS, including: a determination module configured to determine time-frequency resources via which PRS resource blocks are transmitted according to subcarrier spacing; and a detecting and receiving module configured to detect and receive the PRS resource blocks according to the determined time-frequency resources, with each PRS resource block including resource block identification information.

An embodiment of the present disclosure further provides a receiving node, including: a memory, a processor, and a computer program which is stored on the memory and is executable by the processor. When executing the program, the processor performs the receiving method for PRS.

An embodiment of the present disclosure further provides a computer-readable storage medium having computer-executable instructions stored therein. The computer-executable instructions are configured to perform the receiving method for PRS.

Other aspects will become apparent upon reading and understanding the drawings and detailed description.

### BRIEF DESCRIPTION OF THE DRAWINGS

FIG. 1 is a flowchart illustrating a transmitting method for PRS according to the present disclosure;

FIG. 2 is a schematic diagram of a PRS resource block shown in FIG. 1;

FIG. 3 is a distribution diagram of a PRS sequence according to Application Example I of the present disclosure;

FIG. 4 is a distribution diagram of a PRS sequence according to Application Example II of the present disclosure;

FIG. 5 is a distribution diagram of a PRS sequence according to Application Example III of the present disclosure;

FIG. 6 is a distribution diagram of a PRS sequence according to Application Example IV of the present disclosure;

FIG. 7 is a distribution diagram of a PRS sequence according to Application Example V of the present disclosure;

FIG. 8 is a distribution diagram of a PRS sequence according to Application Example VI of the present disclosure;

FIG. 9 is a distribution diagram of a PRS sequence according to Application Example VII of the present disclosure;

FIG. 10 is a distribution diagram of a PRS sequence according to Application Example VIII of the present disclosure;

FIG. 11 is a distribution diagram of a PRS sequence according to Application Example IX of the present disclosure;

FIG. 12 is a flowchart illustrating a receiving method for PRS according to the present disclosure;

FIG. 13 is a schematic structural diagram of a transmitting device for PRS according to the present disclosure;

FIG. 14 is a schematic structural diagram of a receiving device for PRS according to the present disclosure;

FIG. 15 is a schematic structural diagram of a transmitting node according to the present disclosure; and

FIG. 16 is a schematic structural diagram of a receiving node according to the present disclosure.

### DETAILED DESCRIPTION

Embodiments of the present disclosure will be described in detail below with reference to the accompanying drawings.

The steps illustrated in the flowcharts of the drawings may be performed in a computer system such as a set of computer-executable instructions. Although a logical order is illustrated in the flowchart, the steps illustrated or described may be performed in an order different from that described herein in some cases.

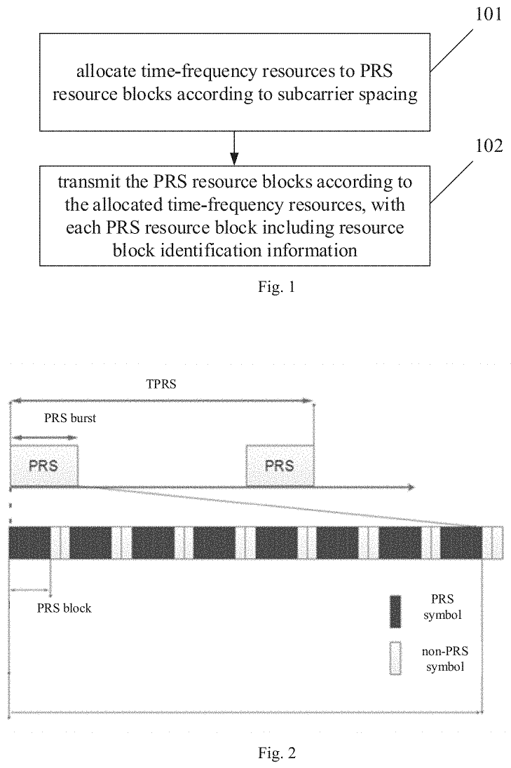

As shown in FIG. 1, a transmitting method for PRS provided by the present disclosure is applied to a transmitting node and includes steps 101 and 102.

At step 101, time-frequency resources are allocated to PRS resource blocks according to subcarrier spacing.

In an embodiment, the time-frequency resources are allocated to the PRS resource blocks with a half subframe (5 ms) taken as a scheduling period.

The subcarrier spacing may be 15 kHZ, 30 kHZ, 120 kHZ, 240 kHZ, etc. A scenario corresponding to each subcarrier spacing is described below.

Scenario A: the subcarrier spacing is 15 kHZ

In the case where the subcarrier spacing is 15 kHZ, a position of a first symbol allocated to each PRS resource block is {2, 8}+14·n, where n is a natural number less than or equal to 4.

When a carrier frequency is less than or equal to 3 GHz, n=2, 3; when the carrier frequency is greater than 3 GHz and less than or equal to 6 GHz, n=1, 2, 3, 4.

Scenario B: the subcarrier spacing is 30 kHZ

In the case where the subcarrier spacing is 30 kHZ, a position of a first symbol allocated to each PRS resource block is {2, 8}+14·n, where n is a natural number less than or equal to 7.

In an embodiment, in a scenario where Frequency Division Duplexing (FDD) is adopted, when a carrier frequency is less than or equal to 3 GHz, n=2, 3; when the carrier frequency is greater than 3 GHz and less than or equal to 6 GHz, n=4, 5, 6, 7.

In an embodiment, in a scenario where Time Division Duplexing (TDD) is adopted, when a carrier frequency is less than or equal to 2.4 GHz, n=2, 3; when the carrier frequency is greater than 2.4 GHz and less than or equal to 6 GHz, n=4, 5, 6, 7.

Scenario C: the subcarrier spacing is 120 kHZ

In the case where the subcarrier spacing is 120 kHZ, a position of a first symbol allocated to each PRS resource block is {4, 8, 16, 20}+28·n, where n=1, 2, 3, 4, 6, 7, 8, 9, 11, 12, 13, 14, 16, 17, 18, 19.

Scenario D: the subcarrier spacing is 240 kHZ

In the case where the subcarrier spacing is 240 kHZ, a position of a first symbol allocated to each PRS resource block is {4, 8, 16, 20, 32, 36, 40, 44}+56·n, where n=10, 11, 12, 13, 15, 16, 17, 18.

Carrier frequencies in the Scenarios C and D are greater than 6 GHz.

According the embodiments of the present disclosure, the positions of the first symbols allocated to the PRS resource blocks according to the subcarrier spacing allow a PRS sequence to be reasonably distributed in the time-frequency resources, so that a receiving node can easily receive and detect the PRS resource blocks.

At step 102, the PRS resource blocks are transmitted according to the allocated time-frequency resources, with each PRS resource block including resource block identification (ID) information.

When the PRS is transmitted through a beam, the resource block ID information has a corresponding relationship with the beam. That is, when the receiving node learns the resource block ID information, the receiving node also learns the information of the beam through which the PRS is transmitted.

In an embodiment, each PRS resource block includes N_{symb}^{prsb} continuous or discontinuous symbols, with N_{symb}^{prsb}=1, 2, 3, 4, 5, 6.

With reference to FIG. 2, a PRS period (TPRS) includes a plurality of PRS bursts each including a plurality of PRS resource blocks, and each PRS resource block includes N_{symb}^{prsb} continuous or discontinuous symbols. Each PRS resource block corresponds to one beam, and an angle covered by eight beams is 120 degrees. A transmitting node polls the eight beams, and a receiving node receives a corresponding PRS sequence.

In an embodiment, within one scheduling period, signals transmitted by the first N_{symb}^{prsb}−1 symbols in PRS resource blocks transmitted by a same transmitting terminal are the same.

The condition that the signals transmitted by the first N_{symb}^{prsb}−1 symbols in the PRS resource blocks are the same refers to that the signals transmitted by the 0^{th}, 1^{st}, . . . (N_{symb}^{prsb}−1)^{th} symbols in the i^{th} PRS resource block are correspondingly the same as the signals transmitted by the 0^{th}, 1^{st}, . . . (N_{symb}^{prsb}−1)^{th} symbols in the j^{th} PRS resource block.

In an embodiment, a sequence r (m) transmitted by the first N_{symb}^{prsb}−1 symbols in a PRS resource block is generated in a following way:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1$$

An initial value of a sequence c(i) is determined according to at least one of:

cᵢₙᵢₜ=2²⁶·└N_{ID}^{PRS}/256┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=2²⁶·└N_{ID}^{PRS}/256┘+2⁸·(((N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2⁸·(((N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=(2¹³((N_{symb}^{prsb}n_{hf}+(N_{symb}^{slot}n_{s,f}^{u}+l+1−sᵢ)mod N_{symb}^{prsb}+1)·(2N_{ID}^{PRS}+1)+N_{ID}^{PRS})mod 2³¹;

cᵢₙᵢₜ=2¹³·((N_{symb}^{prsb}n_{hf}+(N_{symb}^{slot}n_{s,f}^{u}+l+1−sᵢ)mod N_{symb}^{prsb}+1)·(2·N_{ID}^{PRS}+1)+N_{ID}^{PRS}

where n_{s,f}^{u} is a slot index in a radio frame; l is a symbol index in a slot; N_{symb}^{prsb} is a total number of symbols included in a PRS resource block; N_{symb}^{slot} is a total number of symbols included in a slot; n_{hf} represents a number of a half frame, n_{hf}=0 indicates the first half frame of one subframe and n_{hf}=1 indicates the remaining half frame of the subframe; sᵢ is a position of a first symbol in a corresponding PRS resource block; N_{ID}^{PRS}∈{0, 1, . . . , 8191} is a PRS ID for generating the initial value, the PRS ID may be configured by an upper layer, and the PRS ID is equal to a cell ID N_{ID}^{cell} if the upper layer does not configure the PRS ID; and x is related to a PRS in time domain and is a preset value configured by the upper layer;

$${N}_{C P} = \{ \begin{matrix}1 Normal CP \\ 0 Extended CP\end{matrix} .$$

In an embodiment, a signal transmitted by the last symbol in the PRS resource block includes the resource block ID information.

The resource block ID information may be an ID index of the PRS resource block.

In an embodiment, a sequence r (m) transmitted by the last symbol in the PRS resource block is generated in a following way:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1$$

An initial value of a sequence c(i) is determined according to at least one of:

cᵢₙᵢₜ=2²⁶·└N_{ID}^{PRS}/256┘+2²⁰·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2¹⁹·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=(2¹³·((N_{symb}^{slot}n_{s,f}^{u}+l+1)(2N_{ID}^{PRS}+1)+N_{ID}^{PRS})mod 2³¹;

cᵢₙᵢₜ=(2¹³·(iₚᵣₛ+1)·(2N_{ID}^{PRS}+1)+N_{ID}^{PRS})mod 2³¹;

cᵢₙᵢₜ=2¹²(iₚᵣₛ+1)·(2(N_{ID}^{PRS} mod 4096)+1)+(N_{ID}^{PRS} mod 4096);

cᵢₙᵢₜ=2¹³(iₚᵣₛ+1)·(2(N_{ID}^{PRS} mod 4096)+1)+2(N_{ID}^{PRS} mod 4096)+N_{cp};

cᵢₙᵢₜ=2¹²(iₚᵣₛ+1)(└N_{ID}^{PRS}/N_{symb}^{prsb}┘+1)+2⁶(iₚᵣₛ+1)+(N_{ID}^{PRS} mod N_{symb}^{prsb})

where iₚᵣₛ is an ID index of the PRS resource block and is less than or equal to N_{symb}^{prsb}; n_{s,f}^{u} is a slot index in a radio frame; l is a symbol index in a slot; N_{symb}^{prsb} is a total number of symbols included in a PRS resource block; N_{symb}^{slot} is a total number of symbols included in a slot; n_{hf} represents a number of a half frame, n_{hf}=0 indicates the first half frame of one subframe and n_{hf}=1 indicates the remaining half frame of the subframe; sᵢ is a position of a first symbol in a corresponding PRS resource block; N_{ID}^{PRS}∈{0, 1, . . . , 8191} is a PRS ID for generating the initial value, the PRS ID may be configured by an upper layer, and the PRS ID is equal to a cell ID N_{ID}^{cell} if the upper layer does not configure the PRS ID; and x is related to a PRS in time domain and is a preset value configured by the upper layer;

$${N}_{C P} = \{ \begin{matrix}1 Normal CP \\ 0 Extended CP\end{matrix} .$$

According to the embodiments of the present disclosure, the time-frequency resources are reasonably allocated to the PRS resource blocks which include the resource block ID information, so that the PRSs can be transmitted by means of polling beams.

The transmitting method for PRS is illustrated below by several application examples. In the application examples, a signal generation mode of a signal transmitted by the first N_{symb}^{prsb}−1 symbols in a PRS resource block is referred to as Mode One, and a signal generation mode of a signal transmitted by the last symbol in the PRS resource block is referred to as Mode Two.

### Application Example I

The transmitting method for PRS is applied in the Scenario C or D, that is, the subcarrier spacing is 120 kHZ or 240 kHZ.

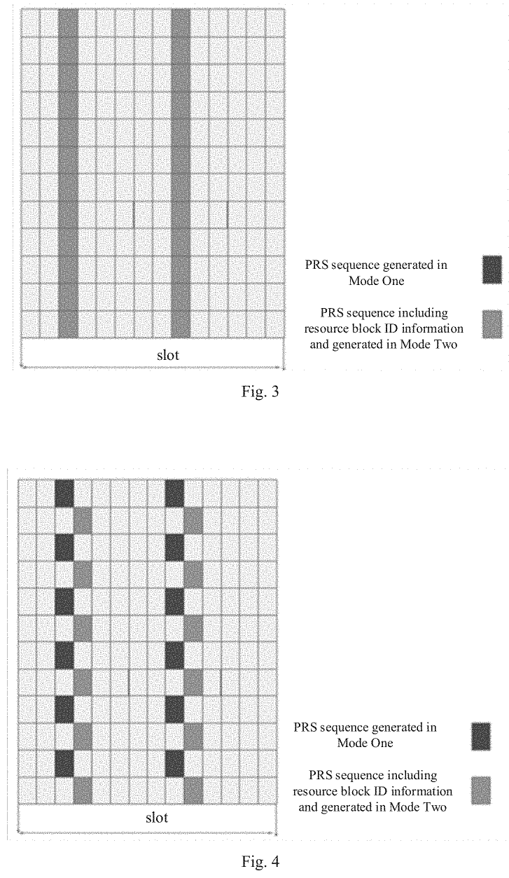

N_{symb}^{prsb} is set to 1, a starting position of each PRS resource block is determined according to the position of the first symbol set in the Scenario C or D of the step 101, resources are allocated to PRSs in the PRS resource block in mode com1, the value of x is 12, and a PRS sequence is determined according to the signal generation mode (Mode Two) of the signal transmitted by the last symbol in the PRS resource block, as shown in FIG. 3.

The value of x corresponding to mode com1 is 12; the value of x corresponding to mode com2 is 6; the value of x corresponding to mode com3 is 4; the value of x corresponding to mode com4 is 3; and the value of x corresponding to mode com6 is 2.

### Application Example II

The transmitting method for PRS is applied in the Scenario C or D, that is, the subcarrier spacing is 120 kHZ or 240 kHZ.

N_{symb}^{prsb} is set to 2, a starting position of each PRS resource block is determined according to the position of the first symbol set in the Scenario C or D of the step 101, resources are allocated to PRSs in mode com2, the value of x is 6, a PRS sequence of a first symbol is determined according to the signal generation mode (Mode One) of the signal transmitted by the first N_{symb}^{prsb}−1 symbols in the PRS resource block, and a PRS sequence of a second symbol is determined according to the signal generation mode (Mode Two) of the signal transmitted by the last symbol in the PRS resource block, as shown in FIG. 4.

### Application Example III

The transmitting method for PRS is applied in the Scenario C or D, that is, the subcarrier spacing is 120 kHZ or 240 kHZ.

N_{symb}^{prsb} is set to 2, a starting position of each PRS resource block is determined according to the position of the first symbol set in the Scenario C or D of the step 101, resources are allocated to PRSs in mode com1, the value of x is 12, a PRS sequence of a first symbol is determined according to the signal generation mode (Mode One) of the signal transmitted by the first N_{symb}^{prsb}−1 symbols in the PRS resource block, and a PRS sequence of a second symbol is determined according to the signal generation mode (Mode Two) of the signal transmitted by the last symbol in the PRS resource block, as shown in FIG. 5.

### Application Example IV

The transmitting method for PRS is applied in the Scenario A, B, C or D, that is, the subcarrier spacing is 15 kHZ, 30 kHZ, 120 kHZ or 240 kHZ.

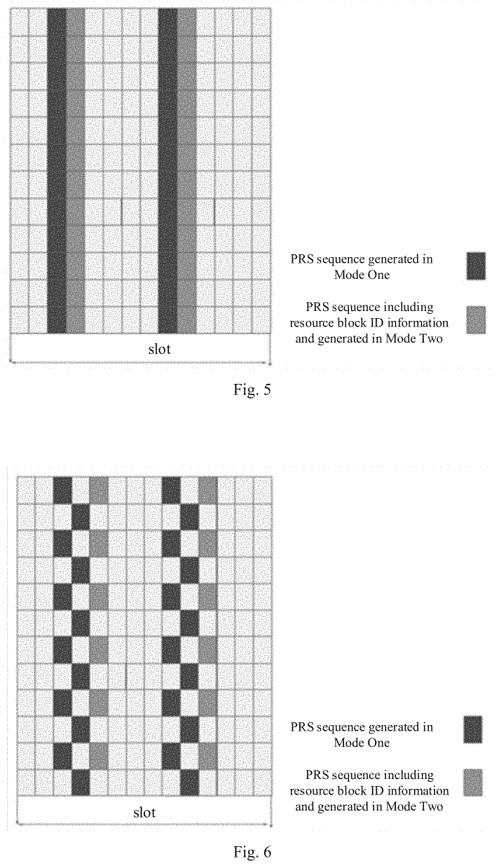

N_{symb}^{prsb} is set to 3, a starting position of each PRS resource block is determined according to the position of the first symbol set in the Scenario A, B, C or D of the step 101, resources are allocated to PRSs in mode com2, the value of x is 6, PRS sequences of first and second symbols are determined according to the signal generation mode (Mode One) of the signal transmitted by the first N_{symb}^{prsb}−1 symbols in the PRS resource block, and a PRS sequence of a third symbol is determined according to the signal generation mode (Mode Two) of the signal transmitted by the last symbol in the PRS resource block, as shown in FIG. 6.

### Application Example V

The transmitting method for PRS is applied in the Scenario A, B, C or D, that is, the subcarrier spacing is 15 kHZ, 30 kHZ, 120 kHZ or 240 kHZ.

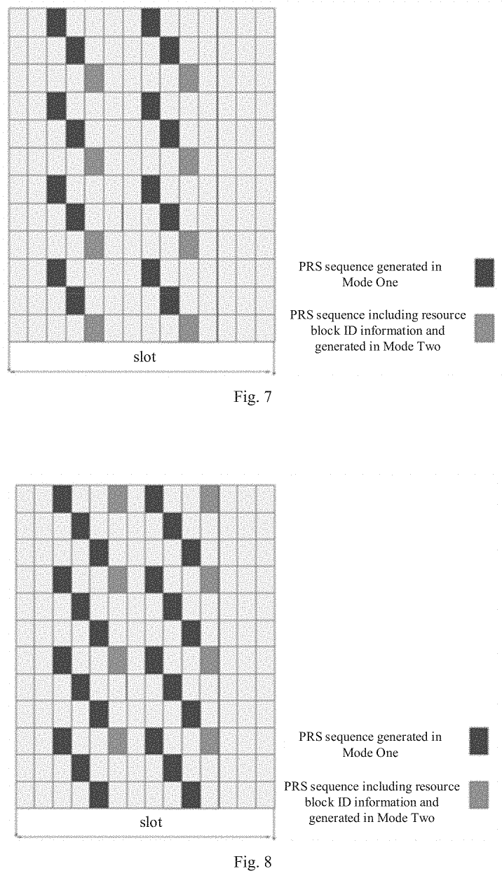

N_{symb}^{prsb} is set to 3, a starting position of each PRS resource block is determined according to the position of the first symbol set in the Scenario A, B, C or D of the step 101, resources are allocated to PRSs in mode com3, the value of x is 4, PRS sequences of first and second symbols are determined according to the signal generation mode (Mode One) of the signal transmitted by the first N_{symb}^{prsb}−1 symbols in the PRS resource block, and a PRS sequence of a third symbol is determined according to the signal generation mode (Mode Two) of the signal transmitted by the last symbol in the PRS resource block, as shown in FIG. 7.

### Application Example VI

The transmitting method for PRS is applied in the Scenario A, B, C or D, that is, the subcarrier spacing is 15 kHZ, 30 kHZ, 120 kHZ or 240 kHZ.

N_{symb}^{prsb} is set to 4, a starting position of each PRS resource block is determined according to the position of the first symbol set in the Scenario A, B, C or D of the step 101, resources are allocated to PRSs in mode com3, the value of x is 4, PRS sequences of first to third symbols are determined according to the signal generation mode (Mode One) of the signal transmitted by the first N_{symb}^{prsb}−1 symbols in the PRS resource block, and a PRS sequence of a fourth symbol is determined according to the signal generation mode (Mode Two) of the signal transmitted by the last symbol in the PRS resource block, as shown in FIG. 8.

### Application Example VII

The transmitting method for PRS is applied in the Scenario A, B, C or D, that is, the subcarrier spacing is 15 kHZ, 30 kHZ, 120 kHZ or 240 kHZ.

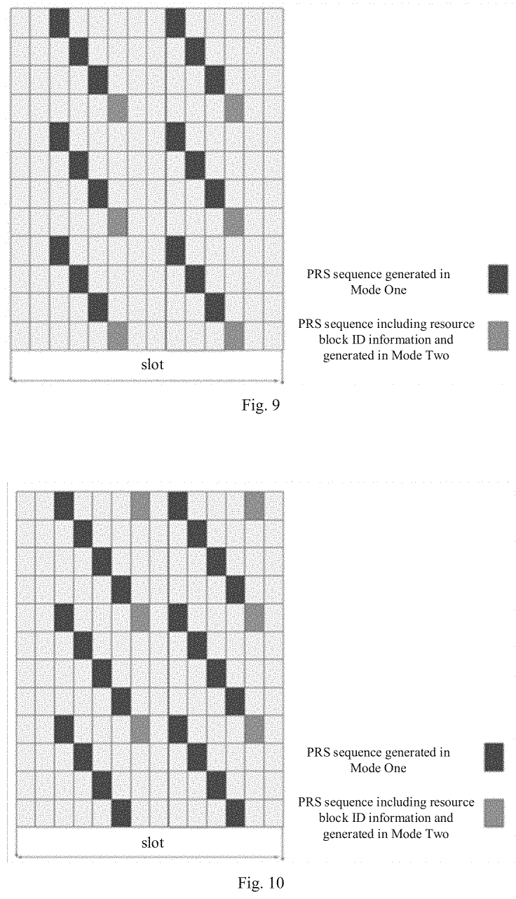

N_{symb}^{prsb} is set to 4, a starting position of each PRS resource block is determined according to the position of the first symbol set in the Scenario A, B, C or D of the step 101, resources are allocated to PRSs in mode com4, the value of x is 3, PRS sequences of first to third symbols are determined according to the signal generation mode (Mode One) of the signal transmitted by the first N_{symb}^{prsb}−1 symbols in the PRS resource block, and a PRS sequence of a fourth symbol is determined according to the signal generation mode (Mode Two) of the signal transmitted by the last symbol in the PRS resource block, as shown in FIG. 9.

### Application Example VIII

The transmitting method for PRS is applied in the Scenario A, B, C or D, that is, the subcarrier spacing is 15 kHZ, 30 kHZ, 120 kHZ or 240 kHZ.

N_{symb}^{prsb} is set to 5, a starting position of each PRS resource block is determined according to the position of the first symbol set in the Scenario A, B, C or D of the step 101, resources are allocated to PRSs in mode com4, the value of x is 3, PRS sequences of first to fourth symbols are determined according to the signal generation mode (Mode One) of the signal transmitted by the first N_{symb}^{prsb}−1 symbols in the PRS resource block, and a PRS sequence of a fifth symbol is determined according to the signal generation mode (Mode Two) of the signal transmitted by the last symbol in the PRS resource block, as shown in FIG. 10.

### Application Example IX

The transmitting method for PRS is applied in the Scenario A, B, C or D, that is, the subcarrier spacing is 15 kHZ, 30 kHZ, 120 kHZ or 240 kHZ.

N_{symb}^{prsb} is set to 6, a starting position of each PRS resource block is determined according to the position of the first symbol set in the Scenario A, B, C or D of the step 101, resources are allocated to PRSs in mode comb, the value of x is 2, PRS sequences of first to fifth symbols are determined according to the signal generation mode (Mode One) of the signal transmitted by the first N_{symb}^{prsb}−1 symbols in the PRS resource block, and a PRS sequence of a sixth symbol is determined according to the signal generation mode (Mode Two) of the signal transmitted by the last symbol in the PRS resource block, as shown in FIG. 11.

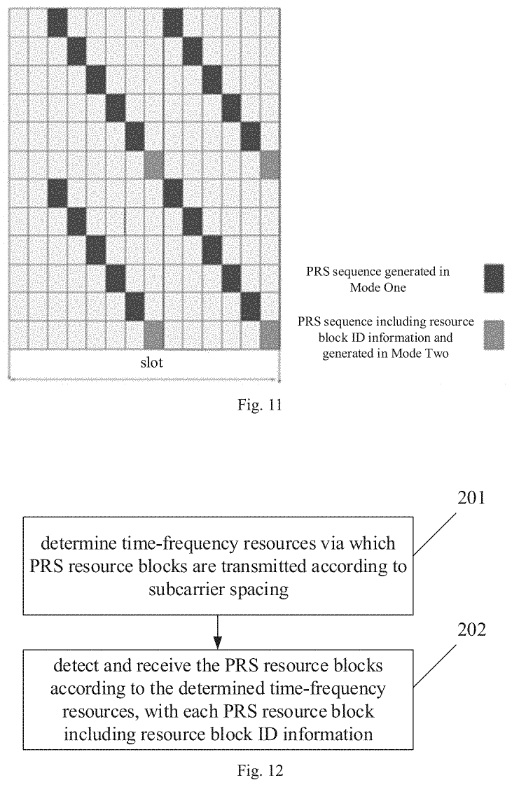

As shown in FIG. 12, a receiving method for PRS provided by an embodiment of the present disclosure is applied to a receiving node and includes steps 201 and 202

At step 201, time-frequency resources via which PRS resource blocks are transmitted are determined according to subcarrier spacing.

Corresponding to the transmitting node, the receiving node determines the time-frequency resources via which the PRS resource blocks are transmitted in the same manner as the transmitting node. A scenario corresponding to each subcarrier spacing is described below.

Scenario A: the subcarrier spacing is 15 kHZ

In the case where the subcarrier spacing is 15 kHZ, it is determined that a position of a first symbol in each PRS resource block is {2, 8}+14·n, where n is a natural number less than or equal to 4.

When a carrier frequency is less than or equal to 3 GHz, n=2, 3; when the carrier frequency is greater than 3 GHz and less than or equal to 6 GHz, n=1, 2, 3, 4.

Scenario B: the subcarrier spacing is 30 kHZ

In the case where the subcarrier spacing is 30 kHZ, it is determined that a position of a first symbol in each PRS resource block is {2, 8}+14·n, where n is a natural number less than or equal to 7.

In an embodiment, in a scenario where FDD is adopted, when a carrier frequency is less than or equal to 3 GHz, n=2, 3; when the carrier frequency is greater than 3 GHz and less than or equal to 6 GHz, n=4, 5, 6, 7.

In an embodiment, in a scenario where TDD is adopted, when a carrier frequency is less than or equal to 2.4 GHz, n=2, 3; when the carrier frequency is greater than 2.4 GHz and less than or equal to 6 GHz, n=4, 5, 6, 7.

Scenario C: the subcarrier spacing is 120 kHZ

In the case where the subcarrier spacing is 120 kHZ, it is determined that a position of a first symbol in each PRS resource block is {4, 8, 16, 20}+28·n, where n=1, 2, 3, 4, 6, 7, 8, 9, 11, 12, 13, 14, 16, 17, 18, 19.

Scenario D: the subcarrier spacing is 240 kHZ

In the case where the subcarrier spacing is 240 kHZ, it is determined that a position of a first symbol in each PRS resource block is {4, 8, 16, 20, 32, 36, 40, 44}+56·n, where n=10, 11, 12, 13, 15, 16, 17, 18.

Carrier frequencies in the Scenarios C and D are greater than 6 GHz.

In the embodiment of the present disclosure, a PRS sequence is reasonably allocated in the time-frequency resources, so that the receiving node can easily receive and detect the PRS sequence.

At step 202, the PRS resource blocks are detected and received according to the determined time-frequency resources, with each PRS resource block including resource block ID information.

When the PRS is transmitted through a beam, the resource block ID information has a corresponding relationship with the beam. That is, when the receiving node learns the resource block ID information, the receiving node also learns the information of the beam through which the PRS is transmitted.

In an embodiment, each PRS resource block includes N_{symb}^{prsb} continuous or discontinuous symbols, with N_{symb}^{prsb}=1, 2, 3, 4, 5, 6.

With reference to FIG. 2, a TPRS includes a plurality of PRS bursts each including a plurality of PRS resource blocks, and each PRS resource block includes N_{symb}^{prsb} continuous or discontinuous symbols.

In an embodiment, a signal transmitted by the last symbol in the PRS resource block includes the resource block ID information.

The resource block ID information may be an ID index of the PRS resource block.

In an embodiment, the step 202 includes: detecting and receiving the first N_{symb}^{prsb}−1 symbols in PRS resource blocks transmitted by one or more transmitting symb nodes; and detecting and receiving the last symbols of the PRS resource blocks, and determining the corresponding resource block ID information of the PRS resource blocks according to the last symbols.

The step of detecting and receiving the first N_{symb}^{prsb}−1 symbols in the PRS resource blocks transmitted by one or more transmitting nodes includes: generating a sequence r(m) transmitted by the first N_{symb}^{prsb}−1 symbols in a PRS resource block in a following way:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1 ;$$

and

detecting the first N_{symb}^{prsb}−1 symbols in the PRS resource blocks according to the generated sequence r(m).

An initial value of a sequence c(i) is determined according to at least one of:

cᵢₙᵢₜ=2²⁶·└N_{ID}^{PRS}/256┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=2²⁶·└N_{ID}^{PRS}/256┘+2⁸·(((N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2⁸·(((N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=(2¹³((N_{symb}^{prsb}n_{hf}+(N_{symb}^{slot}n_{s,f}^{u}+l+1−sᵢ)mod N_{symb}^{prsb}+1)·(2N_{ID}^{PRS}+1)+N_{ID}^{PRS})mod 2³¹;

cᵢₙᵢₜ=2¹³·((N_{symb}^{prsb}n_{hf}+(N_{symb}^{slot}n_{s,f}^{u}+l+1−sᵢ)mod N_{symb}^{prsb}+1)·(2·N_{ID}^{PRS}+1)+N_{ID}^{PRS}

where n_{s,f}^{u} is a slot index in a radio frame; l is a symbol index in a slot; N_{symb}^{prsb} is a total number of symbols included in a PRS resource block; N_{symb}^{slot} is a total number of symbols included in a slot; n_{hf} represents a number of a half frame, n_{hf}=0 indicates the first half frame of one subframe and n_{hf}=1 indicates the remaining half frame of the subframe; sᵢ is a position of a first symbol in a corresponding PRS resource block; N_{ID}^{PRS}∈{0, 1, . . . , 8191} is a PRS ID for generating the initial value, the PRS ID may be configured by an upper layer, and the PRS ID is equal to a cell ID N_{ID}^{cell} if the upper layer does not configure the PRS ID; and x is related to a PRS in time domain and is a preset value configured by the upper layer;

$${N}_{C P} = \{ \begin{matrix}1 Normal CP \\ 0 Extended CP\end{matrix} .$$

In an embodiment, a sequence r (m) transmitted by the last symbol in the PRS resource block is generated in a following way:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1$$

An initial value of a sequence c(i) is determined according to at least one of:

cᵢₙᵢₜ=2²⁶·└N_{ID}^{PRS}/256┘+2²⁰·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2¹⁹·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=(2¹³·((N_{symb}^{slot}n_{s,f}^{u}+l+1)(2N_{ID}^{PRS}+1)+N_{ID}^{PRS})mod 2³¹;

cᵢₙᵢₜ=(2¹³·(iₚᵣₛ+1)·(2N_{ID}^{PRS}+1)+N_{ID}^{PRS})mod 2³¹;

cᵢₙᵢₜ=2¹²(iₚᵣₛ+1)·(2(N_{ID}^{PRS} mod 4096)+1)+(N_{ID}^{PRS} mod 4096);

cᵢₙᵢₜ=2¹³(iₚᵣₛ+1)·(2(N_{ID}^{PRS} mod 4096)+1)+2(N_{ID}^{PRS} mod 4096)+N_{cp};

cᵢₙᵢₜ=2¹²(iₚᵣₛ+1)(└N_{ID}^{PRS}/N_{symb}^{prsb}┘+1)+2⁶(iₚᵣₛ+1)+(N_{ID}^{PRS} mod N_{symb}^{prsb})

where iₚᵣₛ is an ID index of the PRS resource block and is less than or equal to N_{symb}^{prsb}; n_{s,f}^{u} is a slot index in a radio frame; l is a symbol index in a slot, N_{symb}^{prsb} is a total number of symbols included in a PRS resource block; NZ is a total number of symbols included in a slot; n_{hf} represents a number of a half frame, n_{hf}=0 indicates the first half frame of one subframe and n_{hf}=1 in the remaining half frame of the subframe; s, is a position of a first symbol in a corresponding PRS resource block; N_{ID}^{PRs}∈{0, 1, . . . , 8191} is a PRS ID for generating the initial value, the PRS ID may be configured by an upper layer, and the PRS ID is equal to a cell ID Ng if the upper layer does not configure the PRS ID; and x is related to a PRS in time domain and is a preset value configured by the upper layer;

$${N}_{C P} = \{ \begin{matrix}1 Normal CP \\ 0 Extended CP\end{matrix} .$$

The receiving node can detect and determine corresponding resource block ID information according to the above way of generating the last symbol in the PRS resource block.

In an embodiment, after the steps of detecting and receiving the last symbol in the PRS resource block and determining the corresponding resource block ID information of the PRS resource block according to the last symbol, the method further includes: detecting all PRS sequences in the PRS resource blocks to obtain arrival time of the PRS sequences transmitted by the different transmitting nodes.

By detecting all the PRS sequences in the PRS resource blocks, the arrival time of the PRS sequences transmitted by the different transmitting nodes can be obtained, so that a time difference can be obtained, and the position information of the receiving node itself can be determined according to the time difference.

The embodiments can achieve detection of the resource block ID information of the PRS resource blocks without significantly increasing the detection time, thereby realizing time difference-based positioning in scenarios where the PRSs are transmitted by means of polling beams.

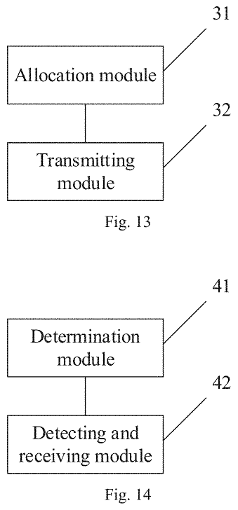

As shown in FIG. 13, an embodiment of the present disclosure further provides a transmitting device for PRS, including an allocation module 31 and a transmitting module 32.

The allocation module 31 is configured to allocate time-frequency resources to PRS resource blocks according to subcarrier spacing.

The transmitting module 32 is configured to transmit the PRS resource blocks according to the allocated time-frequency resources, with each PRS resource block including resource block ID information.

In an embodiment, the allocation module 31 is configured to allocate the time-frequency resources to the PRS resource blocks with a half subframe taken as a scheduling period.

In an embodiment, the allocation module 31 is configured to allocate a position {2, 8}+14·n to a first symbol in each PRS resource block when the subcarrier spacing is 15 kHZ, where n is a natural number less than or equal to 4.

In an embodiment, when a carrier frequency is less than or equal to 3 GHz, n=2, 3; when the carrier frequency is greater than 3 GHz and less than or equal to 6 GHz, n=1, 2, 3, 4.

In an embodiment, the allocation module 31 is configured to allocate a position {2, 8}+14·n to a first symbol in each PRS resource block when the subcarrier spacing is 30 kHZ, where n is a natural number less than or equal to 7.

In an embodiment, in a scenario where FDD is adopted, n=2, 3 when a carrier frequency is less than or equal to 3 GHz and n=4, 5, 6, 7 when the carrier frequency is greater than 3 GHz and less than or equal to 6 GHz; and in a scenario where TDD is adopted, n=2, 3 when a carrier frequency is less than or equal to 2.4 GHz and n=4, 5, 6, 7 when the carrier frequency is greater than 2.4 GHz and less than or equal to 6 GHz.

In an embodiment, the allocation module 31 is configured to allocate a position {4, 8, 16, 20}+28·n to a first symbol in each PRS resource block when the subcarrier spacing is 120 kHZ, where n=1, 2, 3, 4, 6, 7, 8, 9, 11, 12, 13, 14, 16, 17, 18, 19.

In an embodiment, the allocation module 31 is configured to allocate a position {4, 8, 16, 20, 32, 36, 40, 44}+56·n to a first symbol in each PRS resource block when the subcarrier spacing is 240 kHZ, where n=10, 11, 12, 13, 15, 16, 17, 18.

In an embodiment, each PRS resource block includes N_{symb}^{prsb} continuous or discontinuous symbols, with N_{symb}^{prsb}=1, 2, 3, 4, 5, 6.

In an embodiment, within one scheduling period, signals transmitted by the first N_{symb}^{prsb}−1 symbols in PRS resource blocks transmitted by a same transmitting terminal are the same.

In an embodiment, a sequence r(m) transmitted by the first N_{symb}^{prsb}−1 symbols in a PRS resource block is generated in a following way:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1$$

An initial value of a sequence c(i) is determined according to at least one of:

cᵢₙᵢₜ=2²⁶·└N_{ID}^{PRS}/256┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=2²⁶·└N_{ID}^{PRS}/256┘+2⁸·(((N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2⁸·(((N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=(2¹³((N_{symb}^{prsb}n_{hf}+(N_{symb}^{slot}n_{s,f}^{u}+l+1−sᵢ)mod N_{symb}^{prsb}+1)·(2N_{ID}^{PRS}+1)+N_{ID}^{PRS})mod 2³¹;

cᵢₙᵢₜ=2¹³·((N_{symb}^{prsb}n_{hf}+(N_{symb}^{slot}n_{s,f}^{u}+l+1−sᵢ)mod N_{symb}^{prsb}+1)·(2·N_{ID}^{PRS}+1)+N_{ID}^{PRS}

where n_{s,f}^{u} is a slot index in a radio frame; l is a symbol index in a slot; N_{symb}^{prsb} is a total number of symbols included in a PRS resource block; N_{symb}^{prsb} is a total number of symbols included in a slot; n_{hf} represents a number of a half frame, n_{hf}=0 indicates the first half frame of one subframe and n_{hf}=1 indicates the remaining half frame of the subframe; sᵢ is a position of a first symbol in a corresponding PRS resource block; N_{ID}^{PRS}∈{0, 1, . . . , 8191} is a PRS ID for generating the initial value, the PRS ID may be configured by an upper layer, and the PRS ID is equal to a cell ID N_{ID}^{cell} if the upper layer does not configure the PRS ID; and x is related to a PRS in time domain and is a preset value configured by the upper layer;

$${N}_{C P} = \{ \begin{matrix}1 Normal CP \\ 0 Extended CP\end{matrix} .$$

In an embodiment, a signal transmitted by the last symbol in the PRS resource block includes the resource block ID information.

In an embodiment, a sequence r(m) transmitted by the last symbol in the PRS resource block is generated in a following way:

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1$$

An initial value of a sequence c(i) is determined according to at least one of:

cᵢₙᵢₜ=2²⁶·└N_{ID}^{PRS}/256┘+2²⁰·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);

cᵢₙᵢₜ=2²⁵·└N_{ID}^{PRS}/128┘+2¹⁹·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};

cᵢₙᵢₜ=(2¹³·((N_{symb}^{slot}n_{s,f}^{u}+l+1)(2N_{ID}^{PRS}+1)+N_{ID}^{PRS})mod 2³¹;

cᵢₙᵢₜ=(2¹³·(iₚᵣₛ+1)·(2N_{ID}^{PRS}+1)+N_{ID}^{PRS})mod 2³¹;

cᵢₙᵢₜ=2¹²(iₚᵣₛ+1)·(2(N_{ID}^{PRS} mod 4096)+1)+(N_{ID}^{PRS} mod 4096);

cᵢₙᵢₜ=2¹³(iₚᵣₛ+1)·(2(N_{ID}^{PRS} mod 4096)+1)+2(N_{ID}^{PRS} mod 4096)+N_{cp};

cᵢₙᵢₜ=2¹²(iₚᵣₛ+1)(└N_{ID}^{PRS}/N_{symb}^{prsb}┘+1)+2⁶(iₚᵣₛ+1)+(N_{ID}^{PRS} mod N_{symb}^{prsb})

where iₚᵣₛ is an ID index of the PRS resource block and is less than or equal to N_{symb}^{prsb}; n_{s,f}^{u} is a slot index in a radio frame; l is a symbol index in a slot; N_{symb}^{prsb} is a total number of symbols included in a PRS resource block; N_{symb}^{slot} is a total number of symbols included in a slot; n_{hf} represents a number of a half frame, n_{hf}=0 indicates the first half frame of one subframe and n_{hf}=1 indicates the remaining half frame of the subframe; sᵢ is a position of a first symbol in a corresponding PRS resource block; N_{ID}^{PRS}∈{0, 1, . . . , 8191} is a PRS ID for generating the initial value, the PRS ID may be configured by an upper layer, and the PRS ID is equal to a cell ID N_{ID}^{cell} if the upper layer does not configure the PRS ID; and x is related to a PRS in time domain and is a preset value configured by the upper layer;

$${N}_{C P} = \{ \begin{matrix}1 Normal CP \\ 0 Extended CP\end{matrix} .$$

According to the embodiments of the present disclosure, the time-frequency resources are reasonably allocated to the PRS resource blocks which include the resource block ID information, so that the PRSs can be transmitted by means of polling beams.

As shown in FIG. 14, an embodiment of the present disclosure further provides a receiving device for PRS, including a determination module 41 and a detecting and receiving module 42.

The determination module 41 is configured to determine time-frequency resources via which PRS resource blocks are transmitted according to subcarrier spacing.

The detecting and receiving module 42 is configured to detect and receive the PRS resource blocks according to the determined time-frequency resources, with each PRS resource block including resource block ID information.

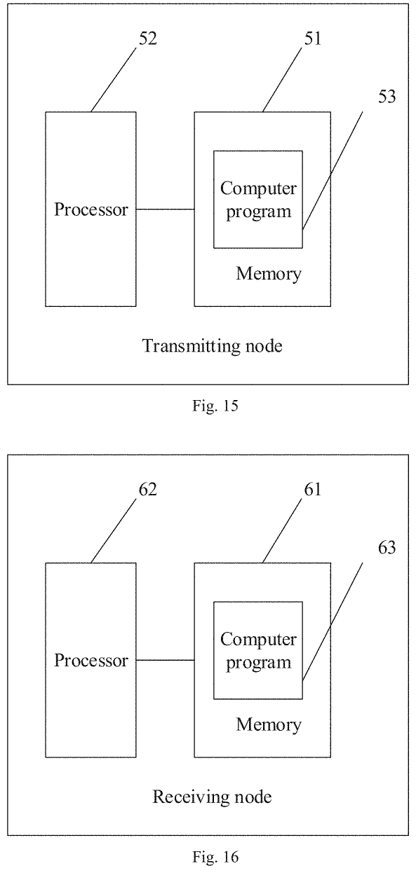

As shown in FIG. 15, an embodiment of the present disclosure further provides a transmitting node, including: a memory 51, a processor 52, and a computer program 53 which is stored on the memory 51 and is executable by the processor 52. When executing the program 53, the processor 52 performs the transmitting method for PRS according to the present disclosure.

The transmitting node may be a device configured to transmit a PRS, such as a base station.

As shown in FIG. 16, an embodiment of the present disclosure further provides a receiving node, including: a memory 61, a processor 62 and a computer program 63 which is stored on the memory 61 and is executable by the processor 62. When executing the program 63, the processor 62 performs the receiving method for PRS according to the present disclosure.

The receiving node may be a device configured to receive a PRS, such as a User Equipment (UE).

An embodiment of the present disclosure further provides a computer-readable storage medium having computer-executable instructions stored therein. The computer-executable instructions are configured to perform the transmitting method for PRS according to the present disclosure.

An embodiment of the present disclosure further provides a computer-readable storage medium having computer-executable instructions stored therein. The computer-executable instructions are configured to perform the receiving method for PRS according to the present disclosure.

In the embodiments, the above storage media may include, but are not limited to, various media capable of storing program codes, such as a Universal Serial Bus Flash Disk (USB flash disk), a Read-Only Memory (ROM), a Random Access Memory (RAM), a mobile hard disk, a magnetic disk and an optical disc.

It should be understood by those of ordinary skill in the art that the functional modules/units in all or some of the steps, the systems, and the devices in the methods disclosed above may be implemented as software, firmware, hardware, or suitable combinations thereof. If implemented as hardware, the division between the functional modules/units stated above is not necessarily corresponding to the division of physical components; for example, one physical component may have a plurality of functions, or one function or step may be performed through cooperation of several physical components. Some or all of the components may be implemented as software executed by a processor, such as a digital signal processor or a microprocessor, or may be implemented as hardware, or may be implemented as an integrated circuit, such as an application specific integrated circuit. Such software may be distributed on computer-readable media, which may include computer storage media (or non-transitory media) and communication media (or transitory media). As well known by those of ordinary skill in the art, the term “computer storage medium” includes volatile/nonvolatile and removable/non-removable media used in any method or technology for storing information (such as computer-readable instructions, data structures, program modules and other data). The computer storage media include, but are not limited to, an RAM, an ROM, an Electrically Erasable Programmable Read-Only Memory (EEPROM), a flash memory or other memory techniques, a Compact Disc Read Only Memory (CD-ROM), a Digital Versatile Disc (DVD) or other optical discs, a magnetic cassette, a magnetic tape, a magnetic disk or other magnetic storage devices, or any other media which can be configured to store the desired information and can be accessed by a computer. In addition, it is well known by those of ordinary skill in the art that the communication media generally include computer-readable instructions, data structures, program modules, or other data in modulated data signals such as carrier wave or other transmission mechanism, and may include any information delivery medium.

1. A transmitting method for positioning reference signal (PRS), comprising:
allocating time-frequency resources to PRS resource blocks according to subcarrier spacing; and
transmitting the PRS resource blocks according to the allocated time-frequency resources, wherein each PRS resource block comprises resource block identification information.

2. The method of claim 1, wherein the step of allocating the time-frequency resources to the PRS resource blocks according to the subcarrier spacing comprises:
allocating the time-frequency resources to the PRS resource blocks with a half subframe taken as a scheduling period.

3. The method of claim 1, wherein the step of allocating the time-frequency resources to the PRS resource blocks according to the subcarrier spacing comprises:
in response to the subcarrier spacing of 15 kHZ, allocating a position {2, 8}+14·n to a first symbol in each PRS resource block, where n is a natural number less than or equal to 4.

4. The method of claim 3, wherein
in response to a carrier frequency being less than or equal to 3 GHz, n=2, 3; in response to the carrier frequency is greater than 3 GHz and less than or equal to 6 GHz, n=1, 2, 3, 4.

5. The method of claim 1, wherein the step of allocating the time-frequency resources to the PRS resource blocks according to the subcarrier spacing comprises:
in response to the subcarrier spacing of 30 kHZ, allocating a position {2, 8}+14·n to a first symbol in each PRS resource block, where n is a natural number less than or equal to 7.

6. The method of claim 5, wherein
in a scenario where Frequency Division Duplexing (FDD) is adopted, in response to a carrier frequency being less than or equal to 3 GHz, n=2, 3; in response to the carrier frequency being greater than 3 GHz and less than or equal to 6 GHz, n=4, 5, 6, 7; and
in a scenario where Time Division Duplexing (TDD) is adopted, in response to the carrier frequency being less than or equal to 2.4 GHz, n=2, 3; in response to the carrier frequency being greater than 2.4 GHz and less than or equal to 6 GHz, n=4, 5, 6, 7.

7. The method of claim 1, wherein the step of allocating the time-frequency resources to the PRS resource blocks according to the subcarrier spacing comprises:
in response to the subcarrier spacing of 120 kHZ, allocating a position {4, 8, 16, 20}+28·n to a first symbol in each PRS resource block, where n=1, 2, 3, 4, 6, 7, 8, 9, 11, 12, 13, 14, 16, 17, 18, 19.

8. The method of claim 1, wherein the step of allocating the time-frequency resources to the PRS resource blocks according to the subcarrier spacing comprises:
in response to the subcarrier spacing of 240 kHZ, allocating a position {4, 8, 16, 20, 32, 36, 40, 44}+56·n to a first symbol in each PRS resource block, where n=10, 11, 12, 13, 15, 16, 17, 18.

9. The method of claim 1, wherein
each of the PRS resource blocks comprises N_{symb}^{prsb} continuous or discontinuous symbols, with N_{symb}^{prsb}=1, 2, 3, 4, 5, 6.

10. The method of claim 9, wherein
within one scheduling period, signals transmitted by the first N_{symb}^{prsb}−1 symbols in PRS resource blocks transmitted by a same transmitting terminal are the same.

11. The method of claim 10, wherein
a sequence r (m) transmitted by the first N_{symb}^{prsb}−1 symbols in a PRS resource block is generated in a following way:
$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1$$
wherein an initial value cᵢₙᵢₜ of a sequence c(i) is determined according to at least one of:
cᵢₙᵢₜ=2²⁶·└N_{ID}^{PRS}/256┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);
cᵢₙᵢₜ=2²⁵·└N_{ID}^{PRS}/128┘+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};
cᵢₙᵢₜ=2²⁶·└N_{ID}^{PRS}/256┘+2⁸·(((N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);
cᵢₙᵢₜ=2²⁵·└N_{ID}^{PRS}/128┘+2⁸·(((N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};
cᵢₙᵢₜ=(2¹³((N_{symb}^{prsb}n_{hf}+(N_{symb}^{slot}n_{s,f}^{u}+l+1−sᵢ)mod N_{symb}^{prsb}+1)·(2N_{ID}^{PRS}+1)+N_{ID}^{PRS})mod 2³¹;
cᵢₙᵢₜ=2¹³·((N_{symb}^{prsb}n_{hf}+(N_{symb}^{slot}n_{s,f}^{u}+l+1−sᵢ)mod N_{symb}^{prsb}+1)·(2·N_{ID}^{PRS}+1)+N_{ID}^{PRS};
where n_{s,f}^{u} is a slot index in a radio frame; l is a symbol index in a slot; N_{symb}^{prsb} is a total number of symbols included in a PRS resource block; N_{symb}^{slot} is a total number of symbols included in a slot; n_{hf} represents a number of a half frame, n_{hf}=0 indicates the first half frame of one subframe and n_{hf}=1 indicates the remaining half frame of the subframe; sᵢ is a position of a first symbol in a corresponding PRS resource block; N_{ID}^{PRS}∈{0, 1, . . . , 8191} is a PRS identification for generating the initial value; and x is related to a PRS in time domain and is a preset value:

12. (canceled)

13. (canceled)

14. (canceled)

15. (canceled)

16. (canceled)

17. The method of claim 9, wherein
a signal transmitted by the last symbol in the PRS resource block comprises the resource block identification information.

18. The method of claim 17, wherein
a sequence r(m) transmitted by the last symbol in the PRS resource block is generated in a following way:
$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , {xN}_{R B}^{max , DL} - 1$$
wherein an initial value cᵢₙᵢₜ of a sequence c(i) determined according to at least one of:
cᵢₙᵢₜ=2²⁶·└N_{ID}^{PRS}/256┘+2²⁰·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 256)+1))+(N_{ID}^{PRS} mod 256);
cᵢₙᵢₜ=2²⁵·└N_{ID}^{PRS}/128┘+2¹⁹·iₚᵣₛ+2⁸·((N_{symb}^{prsb}n_{hf}+(N_{symb}^{slot}n_{s,f}^{u}+l+1−sᵢ)mod N_{symb}^{prsb}+1)·(2·(N_{ID}^{PRS} mod 128)+1))+2(N_{ID}^{PRS} mod 128)+N_{cp};
cᵢₙᵢₜ=(2¹³·((N_{symb}^{slot}n_{s,f}^{u}+l+1)(2N_{ID}^{PRS}+1)+N_{ID}^{PRS})mod 2³¹;
cᵢₙᵢₜ=(2¹³·(iₚᵣₛ+1)·(2N_{ID}^{PRS}+1)+N_{ID}^{PRS})mod 2³¹;
cᵢₙᵢₜ=2¹²(iₚᵣₛ+1)·(2(N_{ID}^{PRS} mod 4096)+1)+(N_{ID}^{PRS} mod 4096);
cᵢₙᵢₜ=2¹³(iₚᵣₛ+1)·(2(N_{ID}^{PRS} mod 4096)+1)+2(N_{ID}^{PRS} mod 4096)+N_{cp};
cᵢₙᵢₜ=2¹²(iₚᵣₛ+1)(└N_{ID}^{PRS}/N_{symb}^{prsb}┘+1)+2⁶(iₚᵣₛ+1)+(N_{ID}^{PRS} mod N_{symb}^{prsb});
where iₚᵣₛ is an identification index of the PRS resource block and is less than or equal to N_{symb}^{prsb}; n_{s,f}^{u} is a slot index in a radio frame; l is a symbol index in a slot; N_{symb}^{prsb} is a total number of symbols included in a PRS resource block; N_{symb}^{slot} is a f total number of symbols included in a slot; n_{hf} represents a number of a half frame, n_{hf}=0 indicates the first half frame of one subframe and n_{hf}=1 indicates the remaining half frame of the subframe; sᵢ is a position of a first symbol in a corresponding PRS resource block; N_{ID}^{PRS}∈{0, 1, . . . , 8191} is a PRS identification for generating the initial value; and x is related to a PRS in time domain and is a preset values:

19. (canceled)

20. (canceled)

21. (canceled)

22. (canceled)

23. (canceled)

24. (canceled)

25. A receiving method for PRS, comprising:
determining time-frequency resources via which PRS resource blocks are transmitted according to subcarrier spacing; and
detecting and receiving the PRS resource blocks according to the determined time-frequency resources, wherein each PRS resource block comprises resource block identification information.

26. (canceled)

27. A transmitting node, comprising: a memory, a processor, and a computer program which is stored on the memory and is executable by the processor, wherein when executing the program, the processor performs the transmitting method for PRS of claim 1.

28. A computer-readable storage medium having computer-executable instructions stored therein, wherein when the computer-executable instructions are run by a processor, the processor performs the transmitting method for PRS claim 1.

29. (canceled)

30. A receiving node, comprising: a memory, a processor, and a computer program which is stored on the memory and is executable by the processor, wherein when executing the program, the processor performs the receiving method for PRS of claim 25.

31. A computer-readable storage medium having computer-executable instructions stored therein, wherein when the computer-executable instructions are run by a processor, the processor performs the receiving method for PRS of claim 25.
